(19) United States
(12) Patent Application Publication
(10) Pub. No.: US 2023/0306432 A1
(43) Pub. Date: Sep. 28, 2023

(54) TRANSMITTING NOTIFICATIONS BASED ON MACHINE LEARNING MODEL OUTPUTS

(71) Applicant: Capital One Services, LLC, McLean, VA (US)

(72) Inventors: Mehulkumar Jayantilal GARNARA, Glen Allen, VA (US); Lee ADCOCK, Midlothian, VA (US); Vamsi KAVURI, Glen Allen, VA (US)

(21) Appl. No.: 17/656,138

(22) Filed: Mar. 23, 2022

(51) Int. Cl. G06N 5/02; G06Q 20/40; G06Q 20/10

(52) U.S. Cl. CPC G06Q 20/403; G06N 5/022; G06Q 20/10

(57) ABSTRACT

In some implementations, a device may obtain information relating to an amount available in a first account of a user. The device may determine, using a machine learning model, a threshold for a second account of the user based on the amount available in the first account of the user. The device may monitor a balance of the second account to identify when the balance satisfies the threshold determined using the machine learning model. The device may cause, based on the balance of the second account satisfying the threshold determined using the machine learning model, execution of a transfer from the first account to satisfy the balance of the second account. The device may transmit a notification indicating that the transfer from the first account to satisfy the balance of the second account has been executed.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for transmitting notifications based on machine learning model outputs. The system may include one or more memories and one or more processors communicatively coupled to the one or more memories. The one or more processors may be configured to transmit, to a device, a message requesting information relating to an amount available in a first account of a user. The one or more processors may be configured to receive, from the device in response to the message, the information relating to the amount available in the first account of the user. The one or more processors may be configured to determine, using a machine learning model, a threshold for a second account of the user based on the amount available in the first account of the user. The one or more processors may be configured to monitor a balance of the second account of the user to identify when the balance satisfies the threshold determined using the machine learning model. The one or more processors may be configured to cause, based on the balance of the second account of the user satisfying the threshold determined using the machine learning model, execution of a transfer from the first account of the user to satisfy the balance of the second account of the user. The one or more processors may be configured to transmit, to a user device of the user, a notification indicating that the transfer from the first account of the user to satisfy the balance of the second account of the user has been executed.

Some implementations described herein relate to a method of transmitting notifications based on machine learning model outputs. The method may include obtaining, by a device, information relating to an amount available in a first account of a user. The method may include determining, by the device and using a machine learning model, a threshold for a second account of the user based on the amount available in the first account of the user. The method may include monitoring, by the device, a balance of the second account of the user to identify when the balance satisfies the threshold determined using the machine learning model. The method may include causing, by the device and based on the balance of the second account of the user satisfying the threshold determined using the machine learning model, execution of a transfer from the first account of the user to satisfy the balance of the second account of the user. The method may include transmitting, by the device to a user device of the user, a notification indicating that the transfer from the first account of the user to satisfy the balance of the second account of the user has been executed.

Some implementations described herein relate to a non-transitory computer-readable medium that stores a set of instructions for transmitting notifications based on machine learning model outputs. The set of instructions, when executed by one or more processors of a device, may cause the device to obtain information indicating a first account of a user that is to be used for satisfying a balance of a second account of the user. The set of instructions, when executed by the one or more processors of the device, may cause the device to obtain information indicating a threshold for the second account of the user. The set of instructions, when executed by the one or more processors of the device, may cause the device to determine, using a machine learning model, an adjusted threshold for the second account of the user based on the threshold and historical activity data associated with the second account. The set of instructions, when executed by the one or more processors of the device, may cause the device to monitor the balance of the second account of the user to identify when the balance satisfies the adjusted threshold determined using the machine learning model. The set of instructions, when executed by the one or more processors of the device, may cause the device to cause, based on the balance of the second account of the user satisfying the adjusted threshold determined using the machine learning model, execution of a transfer from the first account of the user to satisfy the balance of the second account of the user. The set of instructions, when executed by the one or more processors of the device, may cause the device to transmit, to a user device of the user, a notification indicating that the transfer from the first account of the user to satisfy the balance of the second account of the user has been executed.

### BRIEF DESCRIPTION OF THE DRAWINGS

FIGS. 1A-1F are diagrams of an example implementation relating to transmitting notifications based on machine learning model outputs.

FIG. 2 is a diagram illustrating an example of training and using a machine learning model in connection with determining a threshold for an account.

FIG. 3 is a diagram of an example environment in which systems and/or methods described herein may be implemented.

FIG. 4 is a diagram of example components of one or more devices of FIG. 3.

FIG. 5 is a flowchart of an example process relating to transmitting notifications based on machine learning model outputs.

### DETAILED DESCRIPTION

The following detailed description of example implementations refers to the accompanying drawings. The same reference numbers in different drawings may identify the same or similar elements.

An entity (e.g., a company, an organization, or an institution, among other examples) may maintain accounts for a plurality of users. In some examples, a user may perform transactions in connection with an account maintained by the entity. For example, with regard to a credit card account, the user may make charges to the credit card account, thereby increasing an outstanding balance of the credit card account, and make payments to the credit card account, thereby reducing the outstanding balance of the credit card account. To make a payment to the credit card account, the user may execute a transfer to the credit card account from a payment account (e.g., a deposit account).

In some cases, tracking charges to the credit card account and ensuring that the payment account has an amount available that is sufficient to cover the outstanding balance of the credit card account may be difficult. Accordingly, the payment account may have insufficient funds to cover the outstanding balance of the credit card account, yet payment from the payment account may be attempted or may be configured to occur automatically. This may result in an overdraft or another type of payment failure. Accordingly, an entity associated with the credit card account and/or an entity associated with the payment account (which, in some examples, may be the same entity) may consume computing resources (e.g., processing resources, memory resources, communication resources, and/or power resources, among other examples) associated with attempting to execute the payment, declining the payment (e.g., due to insufficient funds), updating a database to indicate that the payment was declined and/or that an overdraft occurred, notifying the user that the payment was declined and/or that an overdraft occurred, and/or providing instructions or other resources to the user on how to increase an availability of funds of the payment account or on how to make payments for the credit card account, among other examples.

Some implementations described herein provide a transfer system that uses a machine learning model to determine a threshold for an account (e.g., a credit card account) of a user. When an outstanding balance of the account satisfies the threshold, the transfer system may cause execution of a transfer from a payment account (e.g., a deposit account) of the user to satisfy (e.g., pay off or pay down) the outstanding balance of the account. Accordingly, rather than the transfer being made according to a fixed monthly cycle (or another fixed cycle), the transfer occurs on a dynamic schedule based on the outstanding balance of the account. The machine learning model may determine the threshold based on an amount available in the payment account, historical activity associated with the payment account, and/or historical activity associated with the account. Moreover, the machine learning model may determine the threshold further based on an objective of the user, such as maintaining a low balance, improving a credit score, lowering payment amounts, preventing overdraft, or the like.

Furthermore, the transfer system may transmit notifications based on outputs of the machine learning model. For example, the transfer system may transmit, to a user device of the user, a notification indicating the threshold determined by the transfer system, a notification enabling the user to select the threshold from one or more threshold options, a notification enabling the user to increase an amount available in the payment account, a notification enabling the user to increase or decrease the threshold, and/or a notification indicating that the transfer to satisfy the outstanding balance of the account has been executed.

In this way, the transfer system facilitates transfers to satisfy the outstanding balance of the account in a manner that reduces the likelihood of overdrafts or other payment failures. Accordingly, the transfer system reduces consumption of computing resources (e.g., processing resources, memory resources, communication resources, and/or power resources, among other examples) used to attempt to execute a transfer (e.g., that may be declined), to decline the transfer, to update a database to indicate that the transfer was declined and/or that an overdraft occurred, to notify the user that the transfer was declined and/or that an overdraft occurred, and/or to provide instructions or other resources to the user on how to increase an availability of funds or make transfers for satisfying the balance of the account, among other examples.

Further, the transfer system is able to provide the same functionality for multiple accounts (e.g., thousands, tens of thousands, hundreds of thousands, or millions of accounts) of an entity. Accordingly, the transfer system enables multiple transfers (e.g., for thousands, tens of thousands, hundreds of thousands, or millions of accounts) to be executed that would not otherwise be executed. This reduces a likelihood that the multiple accounts will encounter overdrafts or failed transfers, and therefore consumption of computing resources associated with facilitating transfers of the multiple accounts may be reduced.

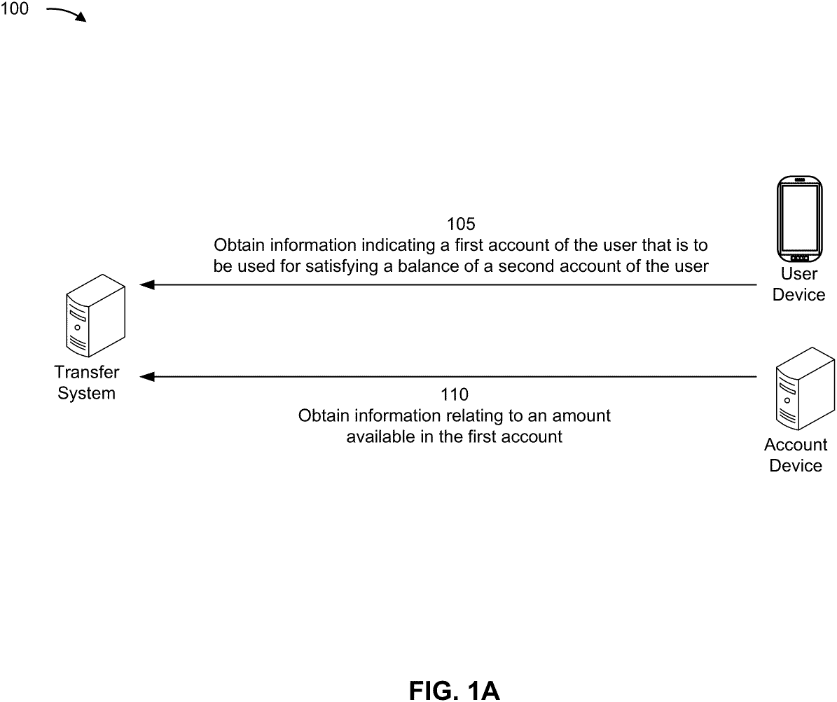

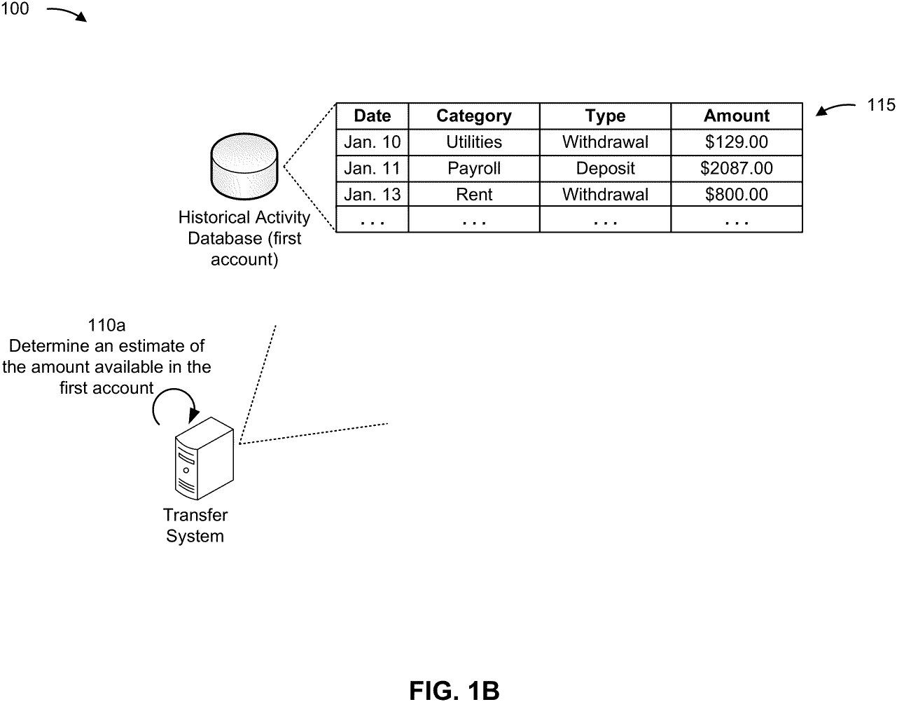

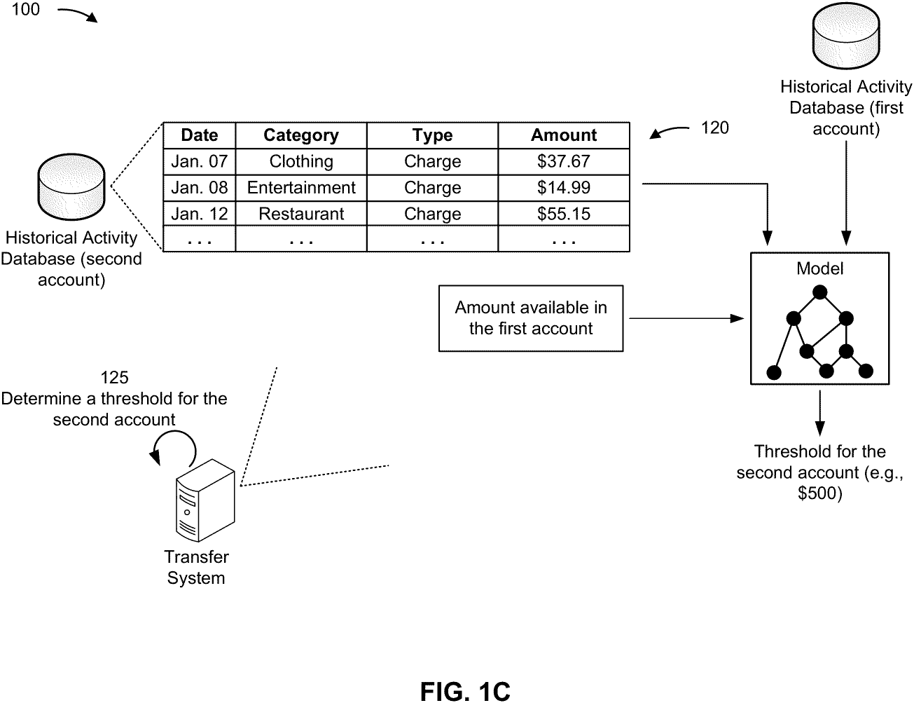

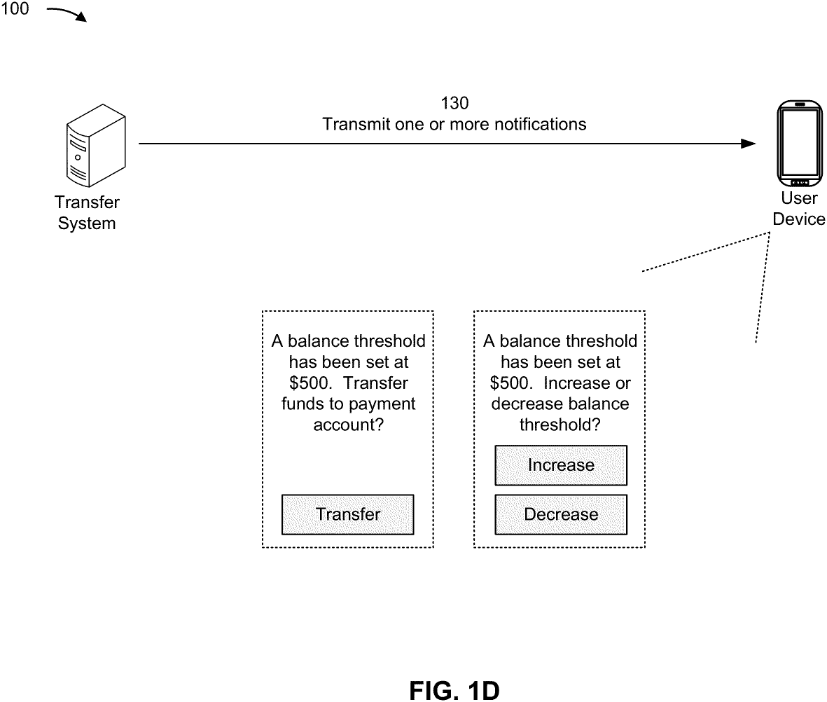

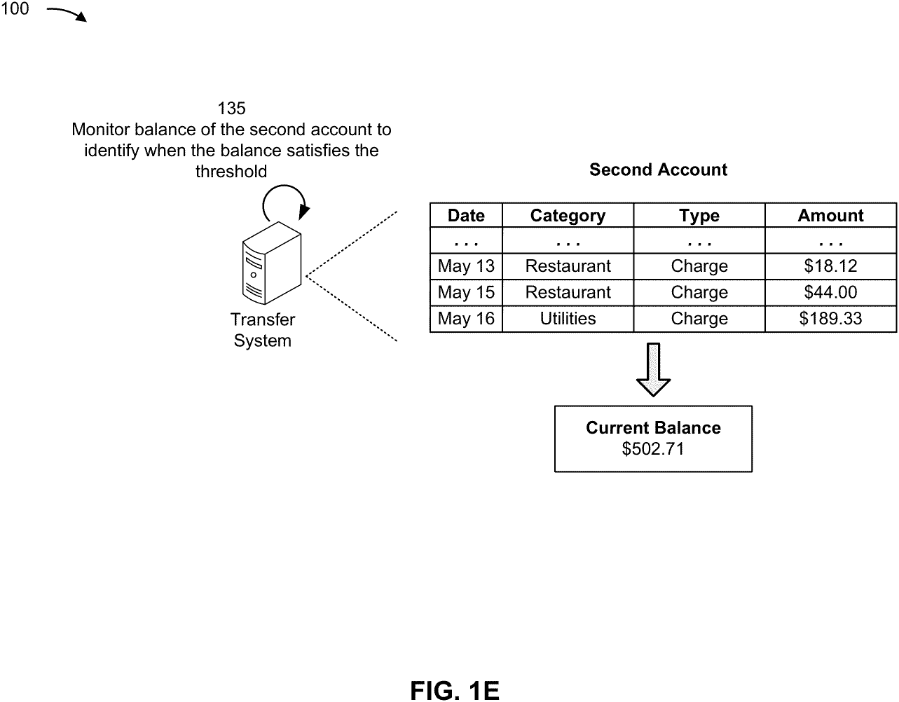

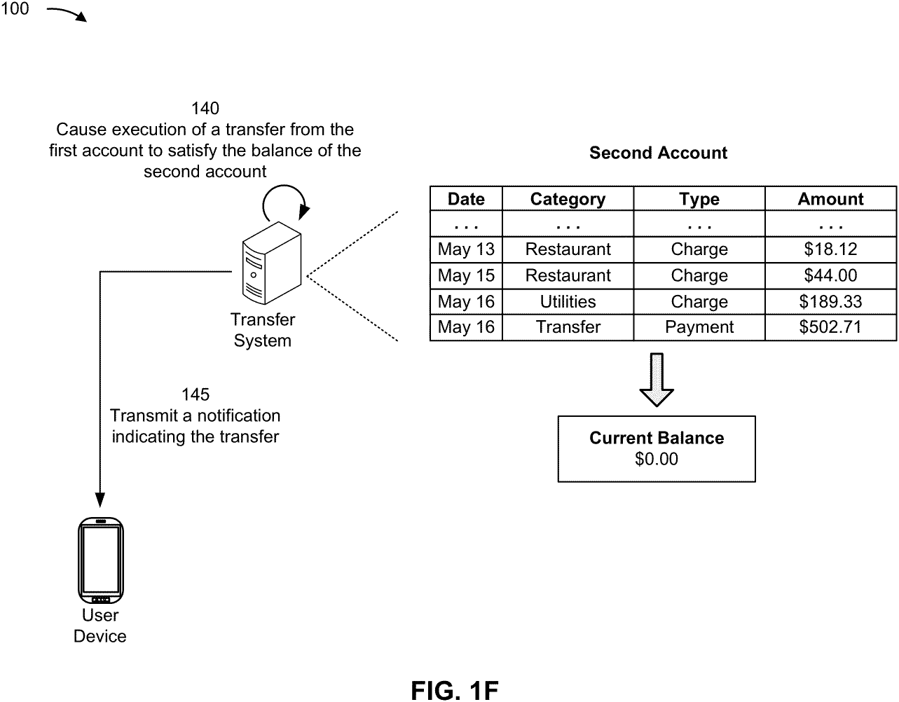

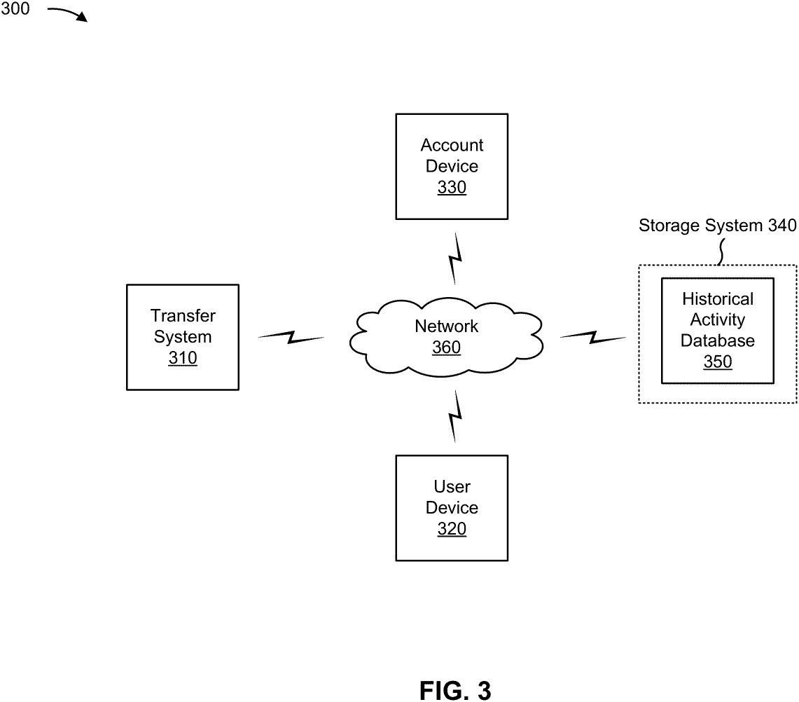

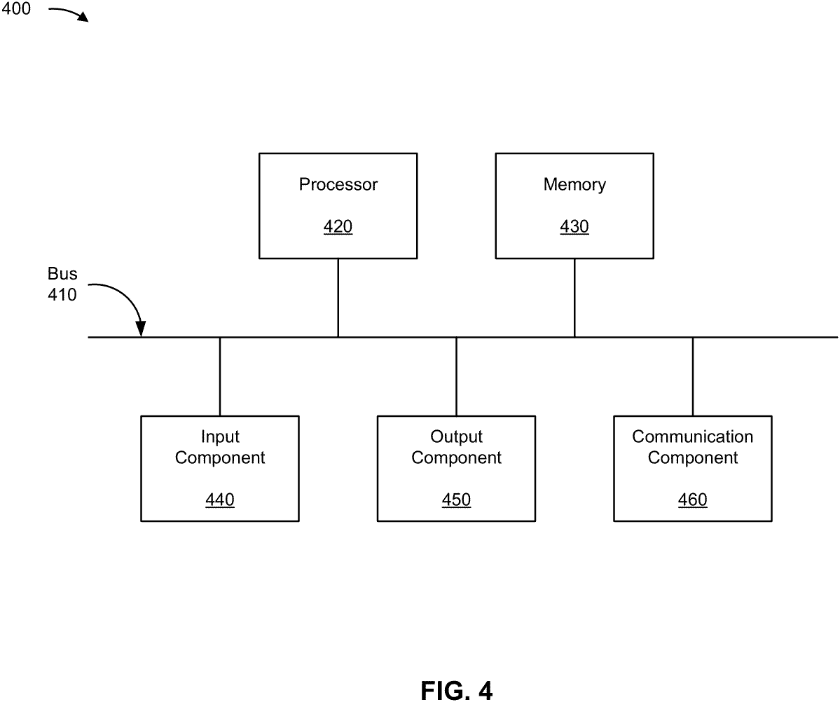

FIGS. 1A-1F are diagrams of an example 100 associated with transmitting notifications based on machine learning model outputs. As shown in FIGS. 1A-1F, example 100 includes a transfer system, a user device, an account device, and one or more databases (e.g., one or more historical activity databases). These devices are described in more detail in connection with FIGS. 3 and 4. The transfer system may be a system for transmitting notifications, as described herein. The transfer system may be associated with an entity (e.g., a financial institution) that maintains accounts for a plurality of users. For example, the entity may maintain credit card accounts for the plurality of users. The account device may be associated with an entity (e.g., a financial institution) that maintains accounts for a plurality of users. For example, the entity may maintain deposit accounts (e.g., checking accounts, savings accounts, or the like) for the plurality of users. The user device may be associated with a user that is associated with an account maintained by the entity associated with the transfer system and an account maintained by the entity associated with the account device. The entity associated with the transfer system and the entity associated with the account device may be the same entity or different entities.

As shown in FIG. 1A, and by reference number 105, the transfer system may obtain information indicating a first account of the user that is to be used for satisfying an outstanding balance of a second account of the user. For example, as shown, the transfer system may receive, from the user device, the information indicating the first account that is to be used for satisfying the outstanding balance of the second account. The first account may be a payment source account, such as a deposit account, a checking account, a savings account, or a money market account, and the second account may be a payment target account, such as a credit card account. The first account and the second account may be maintained for the user by the same entity or by different entities. The transfer system may receive the information indicating the first account from the user device via a user interface provided by the transfer system. The information indicating the first account may be an account identifier associated with the first account. A “balance” of the second account may refer to any type of credit card balance, such as a total credit card balance (e.g., a total amount that is owed), a statement balance (e.g., an amount owed for a billing cycle), or the like.

As shown by reference number 110, the transfer system may obtain information relating to an amount available (e.g., an available balance) in the first account. For example, as shown, the transfer system may receive, from the account device, the information relating to the amount available in the first account (e.g., if the first account and the second account are maintained by different entities). In some implementations, the transfer system may transmit, to the account device, a message requesting the information relating to the amount available in the first account. Here, the transfer system may receive, from the account device and in response to the message, the information relating to the amount available in the first account. The transfer system may transmit the message via an application programming interface (API) (e.g., an API implemented by the account device), and the transfer system may receive the information relating to the amount available in the first account via the API. In some implementations, the transfer system may store the information relating to the amount available in the first account, and the transfer system may obtain the information relating to the amount available in the first account from storage (e.g., if the first account and the second account are maintained by the same entity).

As shown in FIG. 1B, example 100 may include a historical activity database associated with the first account. The historical activity database associated with the first account may store historical activity data 115 associated with the first account. The historical activity data 115 may include one or more entries respectively associated with events (e.g., transactions) for the first account. For example, an event may include an addition to an available balance of the first account (e.g., a deposit to the first account) or a reduction of an available balance of the first account (e.g., a withdrawal from the first account). As shown, an entry of the historical activity data 115 may identify a date and/or a time of an event, a category and/or an entity associated with the event, a type (e.g., deposit or withdrawal) associated with the event, and/or an amount associated with the event.

As shown by reference number 110a, in some implementations, to obtain the information relating to the amount available in the first account, the transfer system may determine an estimate of the amount available in the first account. For example, the transfer system may determine the estimate of the amount available in the first account using a machine learning model. The machine learning model may be trained to identify the estimate of the amount available based on a current time of the month (e.g., a current date) and/or a last-known amount available in the first account, among other examples. The machine learning model may be trained to identify the estimate of the amount available based on the historical activity data 115. In some implementations, the transfer system may determine a prediction of a future amount that will be available in the first account (e.g., at a future date). For example, the transfer system may predict the future amount using a machine learning model. The machine learning model may be trained to predict the future amount based on a current amount available in the first account and/or the historical activity data 115.

As shown in FIG. 1C, example 100 may include a historical activity database associated with the second account. The historical activity database associated with the second account may store historical activity data 120 associated with the second account. The historical activity data 120 may include one or more entries respectively associated with events (e.g., transactions) for the second account. For example, an event may include an addition to an outstanding balance of the second account (e.g., a charge to the second account) or a reduction of an outstanding balance of the second account (e.g., a payment for the second account). As shown, an entry of the historical activity data 120 may identify a date and/or a time of an event, a category and/or an entity associated with the event, a type (e.g., charge or payment) associated with the event, and/or an amount associated with the event.

As shown by reference number 125, the transfer system may determine a threshold for the second account. The threshold may represent a balance amount for the second account that, if met or exceeded by the outstanding balance of the second account, is to trigger satisfaction of the outstanding balance of the second account (e.g., paying off of the outstanding balance of the second account) or at least a portion of the outstanding balance of the second account (e.g., paying down a credit card balance by satisfying a statement balance of the second account). The transfer system may determine the threshold based on the amount available in the first account. For example, the threshold determined by the transfer system may be a first threshold (e.g., a lower threshold) if the amount available in the first account is a first amount (e.g., a lower amount), and the threshold determined by the transfer system may be a second threshold (e.g., a higher threshold) if the amount available in the first account is a second amount (e.g., a higher amount). Additionally, or alternatively, the transfer system may determine the threshold based on the prediction of the future amount available in the first account. For example, the threshold determined by the transfer system may be a first threshold if the prediction of the future amount is a first amount, and the threshold determined by the transfer system may be a second threshold if the prediction of the future amount is a second amount. Additionally, or alternatively, the transfer system may determine the threshold based on the historical activity data 115 associated with the first account. For example, if the historical activity data 115 indicates that additions to the available balance of the first account (e.g., deposits) occur relatively infrequently, then the threshold determined by the transfer system may be relatively higher. Additionally, or alternatively, the transfer system may determine the threshold based on the historical activity data 120 associated with the second account. For example, if the historical activity data 120 indicates that additions to the outstanding balance of the second account (e.g., charges) occur relatively infrequently, then the threshold determined by the transfer system may be relatively lower.

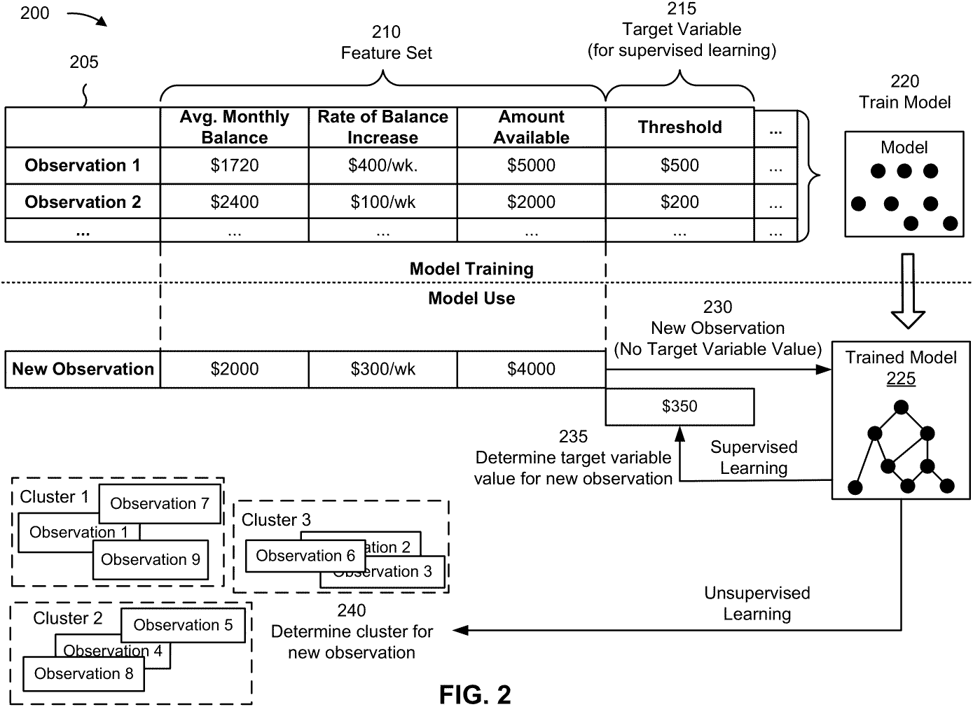

As shown, the transfer system may determine the threshold using a machine learning model (e.g., the same machine learning used to determine the estimate or the prediction of the amount available in the first account or a different machine learning model). The machine learning model may be trained to determine the threshold for the second account based on a feature set that includes a historical monthly outstanding balance of the second account, a historical rate of increase of the outstanding balance of the second account, a value of recurring exchanges (e.g., transactions with the same entities and for the same (or approximately the same) amounts that occur each month) of the second account, the amount available in the first account, a historical monthly amount available in the first account, the prediction of the future amount available in the first account, and/or a historical rate of increase of the amount available in the first account, among other examples. The machine learning model may be trained to determine the threshold for the second account based on the historical activity data 115 and/or the historical activity data 120, as described in connection with FIG. 2.

In some implementations, the transfer system, using the machine learning model (or another machine learning model), may determine a prediction of a date when the outstanding balance of the second account will satisfy (e.g., equal or exceed) the threshold. Here, the transfer system may compare the threshold to a prediction of the future amount available in the first account on the predicted date. If the threshold exceeds the prediction of the future amount available, the transfer system may determine an adjustment to the threshold (as described below), determine a new threshold, refrain from causing transfers from the first account, or the like.

In some implementations, the transfer system may receive, from the user device, information indicating a frequency (e.g., daily, weekly, semimonthly, or the like) preferred by the user for satisfying the outstanding balance of the second account. That is, the user would like to satisfy (e.g., pay off or pay down) the outstanding balance of the second account at the indicated frequency. Based on the frequency, the transfer system may determine one or more threshold options for the second account (e.g., based on the amount available in the first account, the historical activity data 115, and/or the historical activity data 120). For example, the transfer system may determine the threshold options using the machine learning model, described herein. As an example, if the indicated frequency is weekly, the threshold options may include balance amounts of $400 or $500, whereas if the indicated frequency is monthly the threshold options may include balance amounts of $2000 or $2500. Moreover, the transfer system may transmit, to the user device, information indicating the one or more threshold options. For example, the information indicating the threshold options may include information for presentation of one or more input elements, to be presented by the user device, that enables selection among the one or more threshold options. The transfer system may receive, from the user device, information indicating a selection of the one or more threshold options. Accordingly, the threshold for the second account determined by the transfer system may be indicated by the selection. That is, the threshold for the second account may be the threshold option that is selected.

In some implementations, the transfer system may receive, from the user device, information indicating an objective of the user relating to the outstanding balance of the second account. For example, the objective may be to maintain a low balance, to improve a credit score, to lower payment amounts, to prevent overdraft, to minimize the frequency of payments, or the like. Here, the transfer system may determine the threshold for the second account further based on the objective. For example, the transfer system may determine the threshold, based on the objective, using the machine learning model, described herein. As an example, if the objective is a first objective (e.g., preventing overdraft), then the transfer system may determine a first threshold for the second account, and if the objective is a second objective (e.g., improving credit score), then the transfer system may determine a second threshold for the second account. Accordingly, the feature set for the machine learning model may further include information relating to the objective of the user. For example, if the objective is improving a credit score, then the feature set may further include a current credit score of the user, a total available credit across all accounts associated with the user, and/or a credit utilization ratio associated with the user, among other examples).

In some implementations, the transfer system may obtain (e.g., from the account device, from the user device, from a storage of the transfer system, or the like) information indicating the threshold for the second account. For example, the transfer system may receive, from the user device, the information indicating the threshold for the second account (e.g., the threshold may be selected by the user). Accordingly, the threshold for the second account determined by the transfer system may be the indicated threshold. However, the indicated threshold may become outdated or otherwise inappropriate over time (e.g., as behaviors of the user with regard to the first account and/or the second account change).

Here, the transfer system may determine an adjusted threshold for the second account. The transfer system may determine the adjusted threshold based on the indicated threshold and/or the historical activity data 120 (e.g., a historical monthly outstanding balance of the second account, a historical rate of increase of the outstanding balance of the second account, and/or a value of recurring exchanges of the second account, among other examples). In some implementations, the transfer system may determine the adjusted threshold further based on the amount available in the first account, the prediction of the future amount available in the first account, and/or the historical activity data 115. The transfer system may determine the adjusted threshold, based on the indicated threshold, the historical activity data 120, the amount available in the first account, the prediction of the future amount, and/or the historical activity data 115, using the machine learning model, as described herein.

In some implementations, based on determining the adjusted threshold, the transfer system may transmit, to the user device, information indicating the adjusted threshold. For example, the information indicating the adjusted threshold may include information for presentation of an input element, to be presented by the user device, that enables transmission of a message indicating acceptance of the adjusted threshold by the user. Accordingly, the transfer system may receive, from the user device, information indicating acceptance of the adjusted threshold (e.g., the message indicating acceptance of the adjusted threshold).

In some implementations, the threshold (e.g., the threshold, the one or more threshold options, or the adjusted threshold) for the second account determined by the transfer system may be associated with a particular category. For example, the threshold may be associated with a clothing category, an entertainment category, a restaurant category, or the like. Accordingly, the transfer system may determine multiple thresholds (or multiple sets of threshold options or multiple adjusted thresholds) respectively for multiple categories. For example, the transfer system may determine a first threshold for the second account for a first category (e.g., a clothing category) and a second threshold for the second account for a second category (e.g., a restaurant category).

As shown in FIG. 1D, and by reference number 130, the transfer system may transmit one or more notifications to the user device. For example, the transfer system may transmit the one or more notifications based on determining the threshold for the second account. A notification transmitted by the transfer system may indicate the threshold for the second account determined by the transfer system. Additionally, or alternatively, a notification transmitted by the transfer system may include information for presentation of an input element, to be presented by the user device, that enables a transfer to increase the amount available in the first account. For example, the input element may enable an execution of a transfer from a third account of the user to the first account (e.g., to ensure that the amount available in the first account is sufficient to satisfy the threshold for the second account). In some implementations, the notification may provide a recommendation for an amount of the transfer that is determined by the transfer system based on the threshold for the second account. Additionally, or alternatively, a notification transmitted by the transfer system may include information for presentation of an input element, to be presented by the user device, that enables a request from the user device to increase or decrease the threshold. For example, the notification may indicate the threshold determined by the transfer system, and the input element may enable transmission, to the transfer system, of a request to increase or decrease the threshold determined by the transfer system by a particular amount. Additionally, or alternatively, a notification transmitted by the transfer system may indicate that a predicted amount available in the first account, at a future date on which the outstanding balance of the second account is predicted to satisfy the threshold, is insufficient for satisfying the outstanding balance of the second account.

As shown in FIG. 1E, and by reference number 135, the transfer system may monitor the outstanding balance of the second account to identify when the outstanding balance of the second account satisfies the threshold (e.g., the threshold or the adjusted threshold) determined by the transfer system. The outstanding balance may satisfy the threshold when the outstanding balance equals the threshold or exceeds the threshold (as the outstanding balance may never equal the threshold due to variability in charge amounts). The transfer system may monitor the outstanding balance of the second account in real time, periodically, aperiodically (e.g., based on a triggering event), or the like.

In some implementations, when the threshold is associated with a particular category, the transfer system may monitor the outstanding balance of the second account associated with the particular category to identify when the outstanding balance associated with the particular category satisfies the threshold. Here, the transfer system may determine a category associated with an event (e.g., a charge) for the second account based on an entity code associated with the event (e.g., indicating a category associated with an entity involved with the event) and/or based on an entity name associated with the event (e.g., by performing natural language processing of the entity name).

As shown in FIG. 1F, and by reference number 140, the transfer system may cause execution of a transfer (e.g., a payment) from the first account to satisfy the outstanding balance of the second account. For example, the transfer system may cause execution of the transfer based on monitoring the balance of the second account and determining that the outstanding balance of the second account satisfies the threshold (e.g., the threshold or the adjusted threshold). The transfer, to satisfy the outstanding balance of the second account, may be an amount that is equal to the threshold, an amount that is equal to the outstanding balance at the time that the transfer system determines that the outstanding balance satisfies the threshold, or an amount that is equal to the current outstanding balance at the time of the transfer. The transfer system may cause execution of the transfer when (e.g., upon determining that) the outstanding balance of the second account satisfies the threshold, and without regard to a due date for the outstanding balance. For example, the outstanding balance of the second account may be due for payment in a monthly cycle, and the transfer system may cause execution of the transfer on any date without regard to the due date associated with the monthly cycle.

In some implementations, when the threshold is associated with a particular category, the transfer system may cause execution of a transfer from the first account to satisfy the outstanding balance of the second account associated with the particular category. For example, the transfer system may cause execution of the transfer based on monitoring the outstanding balance of the second account associated with the particular category and determining that the outstanding balance associated with the particular category satisfies the threshold.

To cause execution of a transfer from the first account, the transfer system may transmit, to the account device, a message requesting execution of a transfer from the first account to the second account (e.g., when the first account and the second account are maintained by different entities). The message may indicate an amount of the transfer (e.g., an amount that satisfies the balance of the second account) and/or an identifier for the second account. Alternatively, to cause execution of a transfer from the first account, the transfer system may process the transfer from the first account to the second account (e.g., when the first account and the second account are maintained by the same entity)

As shown by reference number 145, the transfer system may transmit, to the user device, a notification indicating that the transfer from the first account to satisfy the outstanding balance of the second account has been executed. In some implementations, the notification may include information for presentation of one or more input elements described in connection with FIG. 1D.

In this way, the transfer system facilitates transfers to satisfy the outstanding balance of the account in a manner that reduces the likelihood of overdrafts or other payment failures. Accordingly, the transfer system reduces consumption of computing resources (e.g., processing resources, memory resources, communication resources, and/or power resources, among other examples) used to attempt to execute a transfer (e.g., that may be declined), to decline the transfer, to update a database to indicate that the transfer was declined and/or that an overdraft occurred, to notify the user that the transfer was declined and/or that an overdraft occurred, and/or to provide instructions or other resources to the user on how to increase an availability of funds or make transfers for satisfying the balance of the account, among other examples.

As indicated above, FIGS. 1A-1F are provided as an example. Other examples may differ from what is described with regard to FIGS. 1A-1F.

FIG. 2 is a diagram illustrating an example 200 of training and using a machine learning model in connection with determining a threshold for an account. The machine learning model training and usage described herein may be performed using a machine learning system. The machine learning system may include or may be included in a computing device, a server, a cloud computing environment, or the like, such as the transfer system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from a storage system (e.g., that includes one or more historical activity databases), as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the transfer system and/or the storage system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of an average monthly balance, a second feature of rate of balance increase, a third feature of an amount available, and so on. As shown, for a first observation, the first feature may have a value of $1720, the second feature may have a value of $400 per week, the third feature may have a value of $5000, and so on. These features and feature values are provided as examples, and may differ in other examples. For example, the feature set may include one or more of the following features: an average monthly outstanding balance (e.g., over a year, over a quarter, or the like) of an account that is to receive a transfer, a rate of increase (e.g., an average rate of increase) of an outstanding balance of the account that is to receive the transfer, a value (e.g., a total value, an average value, or the like) of recurring exchanges of the account that is to receive the transfer, a timing of the recurring exchanges, an average amount per event associated with the account that is to receive the transfer, an amount available (e.g., an available balance) in an account that is to provide the transfer, an average monthly amount available in the account that is to provide the transfer, a rate of increase (e.g., an average rate of increase) of the amount available in the account that is to provide the transfer, a predicted future amount available in the account that is to provide the transfer, an average amount per event associated with the account that is to provide the transfer, a credit score of a user associated with the accounts, a total available credit across all accounts associated with the user, and/or a credit utilization ratio associated with the user, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a threshold for the account that is to receive the transfer, which has a value of $500 for the first observation.

The feature set and target variable described above are provided as examples, and other examples may differ from what is described above. For example, for a target variable of an estimated amount available in the account that is to provide the transfer, the feature set may include an average monthly amount available in the account, a rate of increase of the amount available in the account, an average amount per event associated with the account, and/or a current date, among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical activity data associated with the account that is to receive the transfer and/or historical activity data associated with the account that is to provide the transfer, as described herein. In some implementations, the machine learning system may be associated with an entity that maintains the account that is to receive the transfer, and the historical activity data associated with the account that is to receive the transfer may be stored on one or more devices of the entity and available to the machine learning system. In some implementations, the machine learning system may not be associated with an entity that maintains the account that is to provide the transfer. Here, the machine learning system may obtain (e.g., via an API) bulk data from one or more devices of the entity to derive the historical activity data and/or the machine learning system may at times obtain (e.g., via an API) data from the one or more devices (e.g., in connection with determining an amount available in the account that is to provide the transfer, as described herein), and the machine learning system may derive the historical activity data based on the data that is obtained.

As shown by reference number 230, the machine learning system may apply the trained machine learning model 225 to a new observation, such as by receiving a new observation and inputting the new observation to the trained machine learning model 225. As shown, the new observation may include a first feature of average monthly balance with a value of $2400, a second feature of rate of balance increase with a value of $300 per week, a third feature of an amount available with a value of $4000, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of $350 for the target variable of threshold for the new observation, as shown by reference number 235. Based on this prediction, the machine learning system may provide a recommendation, may provide output for determination of a recommendation, may perform an automated action, and/or may cause an automated action to be performed (e.g., by instructing another device to perform the automated action), among other examples. The automated action may include, for example, transmitting a notification, as described herein.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., low threshold), then the machine learning system may perform an automated action and/or may cause an automated action to be performed (e.g., by instructing another device to perform the automated action) based on classifying the new observation in the first cluster, such as the automated action described above.

As another example, if the machine learning system were to classify the new observation in a second cluster (e.g., high threshold), then the machine learning system may perform or cause performance of a different automated action.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to determine a threshold for an account. The machine learning system enables recognition and/or identification of tens, hundreds, thousands, or millions of features and/or feature values for tens, hundreds, thousands, or millions of observations, thereby increasing accuracy and consistency and reducing delay associated with determining a threshold for an account relative to requiring computing resources to be allocated for tens, hundreds, or thousands of operators to manually determine a threshold for an account using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a transfer system 310, a user device 320, an account device 330, a storage system 340 (e.g., that includes a historical activity database 350), and a network 360. Devices of environment 300 may interconnect via wired connections, wireless connections, or a combination of wired and wireless connections.

The transfer system 310 includes one or more devices capable of receiving, generating, storing, processing, providing, and/or routing information associated with setting a threshold for an account and/or executing a transfer to satisfy a balance of the account, as described elsewhere herein. The transfer system 310 may include a communication device and/or a computing device. For example, the transfer system 310 may include a server, such as an application server, a client server, a web server, a database server, a host server, a proxy server, a virtual server (e.g., executing on computing hardware), or a server in a cloud computing system. In some implementations, the transfer system 310 includes computing hardware used in a cloud computing environment.

The user device 320 includes one or more devices capable of receiving, generating, storing, processing, and/or providing information associated with setting a threshold for an account and/or executing a transfer to satisfy a balance of the account, as described elsewhere herein. The user device 320 may include a communication device and/or a computing device. For example, the user device 320 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The account device 330 includes one or more devices capable of receiving, generating, storing, processing, providing, and/or routing information associated with setting a threshold for an account and/or executing a transfer to satisfy a balance of the account, as described elsewhere herein. The account device 330 may include a communication device and/or a computing device. For example, the account device 330 may include a server, such as an application server, a client server, a web server, a database server, a host server, a proxy server, a virtual server (e.g., executing on computing hardware), or a server in a cloud computing system. In some implementations, the account device 330 includes computing hardware used in a cloud computing environment.

The storage system 340 includes one or more devices capable of receiving, generating, storing, processing, and/or providing information associated with activity associated with one or more accounts, as described elsewhere herein. The storage system 340 may include a communication device and/or a computing device. For example, the storage system 340 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the storage system 340 may include one or more historical activity databases 350, as described elsewhere herein. For example, the one or more historical activity databases 350 may store data relating to history activity associated with one or more accounts.

The network 360 includes one or more wired and/or wireless networks. For example, the network 360 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 360 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to transfer system 310, user device 320, account device 330, and/or storage system 340. In some implementations, transfer system 310, user device 320, account device 330, and/or storage system 340 include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

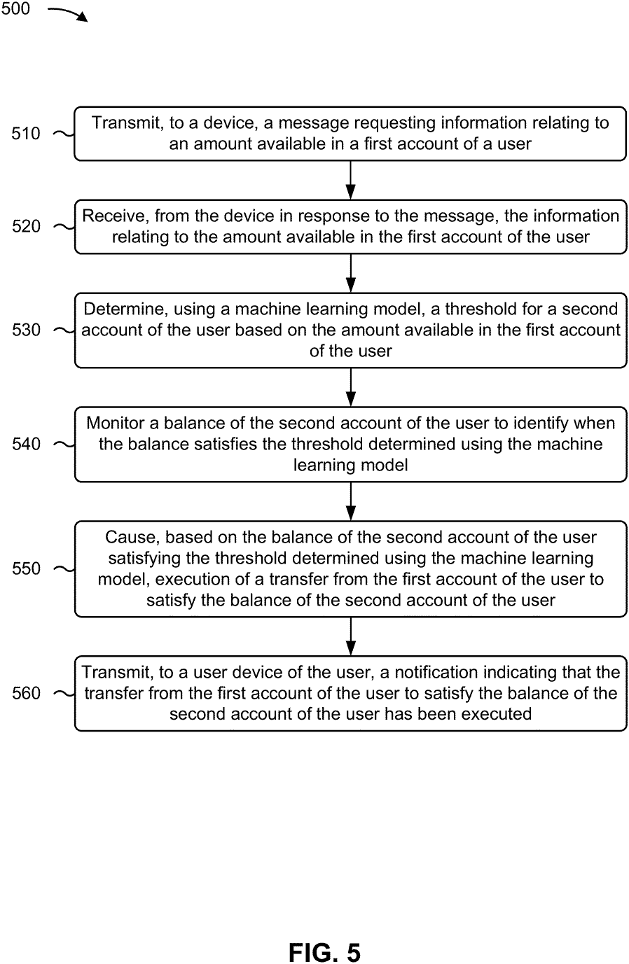

FIG. 5 is a flowchart of an example process 500 associated with transmitting notifications based on machine learning model outputs. In some implementations, one or more process blocks of FIG. 5 may be performed by a device (e.g., transfer system 310). In some implementations, one or more process blocks of FIG. 5 may be performed by another device or a group of devices separate from or including the device, such as user device 320, account device 330, and/or storage system 340. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include transmitting, to a device, a message requesting information relating to an amount available in a first account of a user (block 510). For example, the message may be transmitted via an API. In some implementations, process 500 may include determining an estimate of the amount available in the first account using a machine learning model.

As further shown in FIG. 5, process 500 may include receiving, from the device in response to the message, the information relating to the amount available in the first account of the user (block 520). For example, the information relating to the amount available in the first account may be received via the API.

As further shown in FIG. 5, process 500 may include determining, using a machine learning model, a threshold for a second account of the user based on the amount available in the first account of the user (block 530). The machine learning model may determine the threshold for the second account based on a feature set that includes at least one of: a historical monthly balance of the second account, a historical rate of increase of the balance of the second account, a value of recurring exchanges of the second account, the amount available in the first account, a historical monthly amount available in the first account, a historical rate of increase of the amount available in the first account, or information relating to an objective of the user. In some implementations, process 500 may include receiving information indicating an objective relating to the balance of the second account, and the threshold for the second account is determined further based on the objective.

As further shown in FIG. 5, process 500 may include monitoring a balance of the second account of the user to identify when the balance satisfies the threshold determined using the machine learning model (block 540). For example, the balance of the second account may be monitored in real time, periodically, aperiodically (e.g., based on a triggering event), or the like.

As further shown in FIG. 5, process 500 may include causing, based on the balance of the second account of the user satisfying the threshold determined using the machine learning model, execution of a transfer from the first account of the user to satisfy the balance of the second account of the user (block 550). For example, execution of the transfer may be caused upon determining that the balance of the second account satisfies the threshold, without regard to a due date for the balance of the second account. To cause execution of the transfer from the first account, process 500 may include transmitting a message requesting execution of the transfer from the first account to the second account, or processing the transfer from the first account to the second account.

As further shown in FIG. 5, process 500 may include transmitting, to a user device of the user, a notification indicating that the transfer from the first account of the user to satisfy the balance of the second account of the user has been executed (block 560). Process 500 may include transmitting, to the user device, a different notification that includes information for presentation of an input element, to be presented by the user device, that enables a request to increase or decrease the threshold. Process 500 may include transmitting, to the user device, a different notification that includes information for presentation of an input element, to be presented by the user device, that enables a different transfer to increase the amount available in the first account.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1F.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for transmitting notifications based on machine learning model outputs, the system comprising:
one or more memories; and
one or more processors, communicatively coupled to the one or more memories, configured to:
transmit, to a device, a message requesting information relating to an amount available in a first account of a user;
receive, from the device in response to the message, the information relating to the amount available in the first account of the user;
determine, using a machine learning model, a threshold for a second account of the user based on the amount available in the first account of the user,
wherein the machine learning model is trained, using one or more machine learning algorithms, on historical activity data associated with the first account of the user or the second account of the user, and wherein to determine the threshold for the second account the machine learning model is applied to an observation that includes a feature set corresponding to at least one of the first account of the user or the second account of the user, and
wherein the second account comprises a destination for a transfer from the first account;
monitor a balance of the second account of the user to identify when the balance satisfies the threshold determined using the machine learning model;
cause, based on the balance of the second account of the user satisfying the threshold determined using the machine learning model, execution of the transfer from the first account of the user to the second account of the user, the transfer including an amount based on the balance of the second account of the user; and
transmit, to a user device of the user, a notification indicating that the transfer from the first account of the user to satisfy the balance of the second account of the user has been executed.

2. The system of claim 1, wherein the feature set includes at least one of:
a historical monthly balance of the second account,
a historical rate of increase of the balance of the second account,
a value of recurring exchanges of the second account,
the amount available in the first account,
a historical monthly amount available in the first account,
a historical rate of increase of the amount available in the first account, or
information relating to an objective of the user.

3. The system of claim 1, wherein the threshold is a first threshold if the amount available in the first account is a first amount, and the threshold is a second threshold if the amount available in the first account is a second amount.

4. The system of claim 1, wherein execution of the transfer is caused upon determining that the balance of the second account satisfies the threshold, without regard to a due date for the balance of the second account.

5. The system of claim 1, wherein the threshold is associated with a particular category, and
wherein the one or more processors, to cause execution of the transfer, are configured to:
cause, based on determining that the balance of the second account associated with the particular category satisfies the threshold associated with the particular category, execution of the transfer from the first account to the second account of the user, the amount of the transfer being based on a particular balance of the second account that is associated with the particular category.

6. The system of claim 1, wherein the message is transmitted via an application programming interface (API), and the information relating to the amount available in the first account is received via the API.

7. The system of claim 1, wherein the one or more processors are further configured to:
transmit, to the user device, a different notification that includes information for presentation of an input element, to be presented by the user device, that enables a different transfer to increase the amount available in the first account.

8. The system of claim 1, wherein the one or more processors are further configured to:
transmit, to the user device, a different notification that includes information for presentation of an input element, to be presented by the user device, that enables a request to increase or decrease the threshold.

9. A method of transmitting notifications based on machine learning model outputs, comprising:
obtaining, by a device, information relating to an amount available in a first account of a user;
determining, by the device and using a machine learning model, a threshold for a second account of the user based on the amount available in the first account of the user,
wherein the machine learning model is trained, using one or more machine learning algorithms, on historical activity data associated with the first account of the user or the second account of the user, and wherein to determine the threshold for the second account the machine learning model is applied to an observation that includes a feature set corresponding to at least one of the first account of the user or the second account of the user;
monitoring, by the device, a balance of the second account of the user to identify when the balance satisfies the threshold determined using the machine learning model;
causing, by the device and based on the balance of the second account of the user satisfying the threshold determined using the machine learning model, execution of a transfer from the first account of the user to the second account of the user, the transfer including an amount based on the balance of the second account of the user; and
transmitting, by the device to a user device of the user, a notification indicating that the transfer from the first account of the user to satisfy the balance of the second account of the user has been executed.

10. The method of claim 9, wherein obtaining the information relating to the amount available in the first account comprises:
transmitting, to a different device, a message requesting the information relating to the amount available in the first account; and
receiving, from the different device in response to the message, the information relating to the amount available in the first account.

11. The method of claim 9, wherein obtaining the information relating to the amount available in the first account comprises:
determining an estimate of the amount available in the first account using the machine learning model or a different machine learning model.

12. The method of claim 9, further comprising:
receiving, from the user device, information indicating a frequency preferred by the user for causing execution of the transfer from the first account to the second account;
determining, using the machine learning model, one or more threshold options for the second account based on the frequency;
transmitting, to the user device, information indicating the one or more threshold options; and
receiving, from the user device, information indicating a selection of the one or more threshold options,
wherein the threshold for the second account is indicated by the selection of the one or more threshold options.

13. The method of claim 9, further comprising:
receiving, from the user device, information indicating an objective relating to the balance of the second account,
wherein the threshold for the second account is determined further based on the objective.

14. The method of claim 9, wherein the machine learning model determines the threshold for the second account based on a feature set that includes at least one of:
a historical monthly balance of the second account,
a historical rate of increase of the balance of the second account,
a value of recurring exchanges of the second account,
the amount available in the first account,
a historical monthly amount available in the first account,
a historical rate of increase of the amount available in the first account, or
information relating to an objective of the user.

15. The method of claim 9, wherein execution of the transfer is caused when the balance of the second account satisfies the threshold, without regard to a due date for the balance of the second account.

16. A non-transitory computer-readable medium storing a set of instructions for transmitting notifications based on machine learning model outputs, the set of instructions comprising:
one or more instructions that, when executed by one or more processors of a device, cause the device to:
obtain information indicating a first account of a user that is to be used as a source account for executing a transfer to a destination account associated with the user, the destination account comprising a second account of the user;
obtain information indicating a threshold for the second account of the user;
determine, using a machine learning model, an adjusted threshold for the second account of the user based on the threshold and historical activity data associated with the second account;
monitor a balance of the second account of the user to identify when the balance satisfies the adjusted threshold determined using the machine learning model;
cause, based on the balance of the second account of the user satisfying the adjusted threshold determined using the machine learning model, execution of the transfer from the first account of the user to the second account of the user, the transfer including an amount based on the balance of the second account of the user; and
transmit, to a user device of the user, a notification indicating that the transfer from the first account of the user to satisfy the balance of the second account of the user has been executed.

17. The non-transitory computer-readable medium of claim 16, wherein the one or more instructions that, when executed by the one or more processors of the device cause the device to obtain information indicating the threshold for the second account, cause the device to:
receive the information indicating the threshold for the second account from the user device.

18. The non-transitory computer-readable medium of claim 16, wherein the one or more instructions, when executed by the one or more processors, further cause the device to:
transmit, to the user device, information indicating the adjusted threshold; and
receive, from the user device, information indicating acceptance of the adjusted threshold.

19. The non-transitory computer-readable medium of claim 16, wherein the historical activity data associated with the second account includes data relating to at least one of:
a historical monthly balance of the second account,
a historical rate of increase of the balance of the second account, or
a value of recurring exchanges of the second account.

20. The non-transitory computer-readable medium of claim 16, wherein the adjusted threshold for the second account is determined further based on an amount available in the first account.
